(19) United States
(12) Patent Application Publication
(10) Pub. No.: US 2014/0331154 A1
(43) Pub. Date: Nov. 6, 2014

(54) USER DEFINED INTERFACE SYSTEM AND A METHOD FOR USING THE SAME

(71) Applicant: Carrier Corporation, Farmington, CT (US)

(72) Inventor: Michael A Roher, Fort Wayne, IN (US)

(73) Assignee: Carrier Corporation, Farmington, CT (US)

(21) Appl. No.: 14/248,501

(22) Filed: Apr. 9, 2014

Related U.S. Application Data
(60) Provisional application No. 61/819,609, filed on May 5, 2013.

(51) Int. Cl. G06F 3/0484; G06F 3/0488; G06F 3/0481

(52) U.S. Cl. CPC G06F 3/04842; G06F 3/04817; G06F 3/04845; G06F 3/0488
USPC 715/765

(57) ABSTRACT

A user defined interface system including a processor; a memory; a touchscreen display; and executable software stored in the memory; wherein the executable software generates a plurality of graphical elements, on the display screen; wherein at least one graphical element comprises a data input graphical element and at least one graphical element comprises an informational graphical element; wherein each graphical element includes a height dimension and a width dimension; and wherein at least one graphical element may be selected to be moved to a desired location; and placed at the desired location. A method for configuring graphical elements on a user defined interface system, wherein at least one graphical element comprises a data input graphical element, including the steps: selecting at least one graphical element; moving the selected graphical element to a desired location.

### CROSS REFERENCE TO RELATED APPLICATIONS

The present application is related to, and claims the priority benefit of, U.S. Provisional Patent Application Ser. No. 61/819,609 filed May 5, 2013, the contents of which are hereby incorporated in their entirety into the present disclosure.

### TECHNICAL FIELD OF THE DISCLOSED EMBODIMENTS

The presently disclosed embodiments generally relate to user interfaces, and more particularly, to a user defined interface system, and a method for using the same.

### BACKGROUND OF THE DISCLOSED EMBODIMENTS

A touchscreen user interface system allows a display device such as a cathode ray tube (CRT) or a liquid crystal display (LCD), to also be used as an input device. The touchscreen user interface is typically implemented as a display device overlay that is capable of electronically recognizing changes in resistance, current, or ultra-sonic waves resulting from a screen touch. These changes are programmatically converted to screen coordinates in real time, and are acted upon by an application software for which the touchscreen on the user interface is providing input.

Such user interfaces are pre-programmed by the manufacturer to contain specific graphical elements. These graphical elements are commonly program launch icons, data input icons, or informational icons. In some instances, these graphical elements are pre-defined and fixed in a particular location as the manufacturer deems appropriate. This may lead to user dissatisfaction as the icons are in a location not suitable or disruptive to the user's experience. There is therefore a need for a user interface system that may be configured to place graphical elements, including data input icons and informational icons in a desired location by the user.

### SUMMARY OF THE DISCLOSED EMBODIMENTS

In one aspect, a user interface system is provided. The user interface includes a processor, a memory, a display screen, a touchscreen, and executable software stored in the memory; wherein the executable software generates a plurality of graphical elements, on the display screen, wherein at least one graphical element includes a data input graphical element and at least one graphical element includes an informational graphical element. The entirety of at least one of the graphical elements may be selected, by the user, to be moved to a desired location, and placed at the desired location. In another embodiment, each graphical element includes a height dimension and a width dimension which may be adjusted by the user.

In one aspect, a method to configure a user interface system including software that generates at least one data input graphical element and at least one informational graphical element on a display screen is provided. In one embodiment, the display screen may include a touchscreen. The method includes the step of selecting the entirety of at least one of the data input graphical elements or the entirety of at least one of the informational graphical elements desired to be moved or adjusted. In one embodiment, the step of selecting the entirety of at least one of the data input graphical elements or the entirety of at least one of the informational graphical elements may be performed by an end user. In one embodiment, the entirety of the at least one data input graphical element or the entirety of the at least one informational graphical element is selected by the user touching the touchscreen, with an object where the entirety of the at least one data input graphical element or the entirety of the at least one informational graphical element may be depicted on the display screen.

The method may also include the step of moving the entire selected graphical element to a desired location on the display screen. In one embodiment, the step of moving the entire selected graphical element to a desired location on the display screen may be performed by an end user. In one embodiment, the entire selected graphical element may be moved by sliding the object along the touchscreen, wherein the entire selected graphical element moves across the display screen in concert with the object's movement.

The method further includes the step of placing the entire selected graphical element at the desired location on the display screen. In one embodiment, the step of placing the entire selected graphical element at the desired location on the display screen may be performed by an end user. In one embodiment, the entire selected graphical element is placed at the desired location on the display screen by removing the object from the touchscreen. In another embodiment, the entire selected graphical element may be placed by touching the touchscreen, in a second location where it is desired to place the entire selected graphical element.

The method may also include adjusting the size of the entire selected graphical element. In one embodiment, adjusting the size of the entire selected graphical element may be performed by an end user. In one embodiment, each of the data input graphical elements and each of the informational graphical elements includes an adjustable height dimension and an adjustable width dimension. In one embodiment, the height dimension of the selected graphical element may be adjusted by the user touching the touchscreen with an object, at at least one point and sliding the object in a vertical direction. In one embodiment, the width dimension of the selected graphical element may be adjusted by the user touching the touchscreen, with an object, at at least one point and sliding the object in a horizontal direction. In another embodiment, the height dimension and the width dimension of the selected graphical element may be adjusted by the user touching the touchscreen, with the object, at a corner, and sliding the object in a diagonal direction. In another embodiment, the height dimension and the width dimension of the selected graphical element may be adjusted by the user touching the touchscreen with a pair of objects in close proximity to one another, and moving the pair of objects in opposite directions.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a block diagram of a user interface system having a touchscreen display;

FIG. 2. shows a front view of graphical elements on a user interface system display screen in an exemplary embodiment; and

FIG. 3 is a schematic flow chart of an exemplary embodiment of a method to configure a user interface system.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

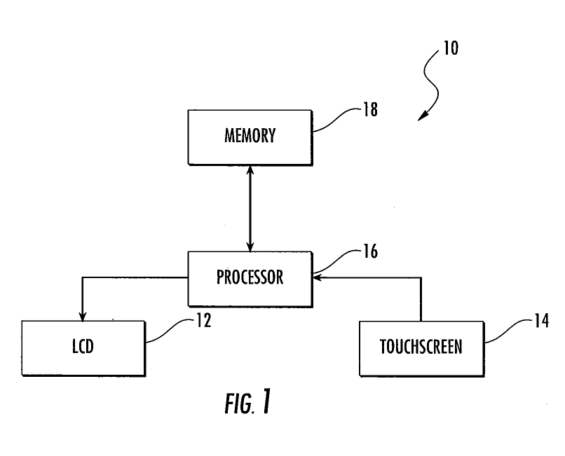

FIG. 1 illustrates a block diagram of a user interface system, indicated generally at 10. Particularly, the user interface system 10 includes a display screen 12, for example a liquid crystal display (LCD) to name one non-limiting example, a touchscreen 14, a processor 16, and a memory 18, for example read only memory (ROM) and electrically erasable programmable read only memory (EEPROM) to name two non-limiting examples. User interface system 10 allows a user to provide inputs to processor 16 by touching portions of touchscreen 14. Visual feedback and prompting messages to the user may be provided by processor 16 through the display screen 12. Touchscreen 14 is positioned in front of the display screen 12, so that locations can be touched to provide particular inputs related to messages and graphical elements 20 appearing on the display screen 12. Processor 16 receives touch event inputs from touchscreen 14 and provides display outputs to display screen 12. Processor 16 is programmed to run executable application software stored in memory 18 that accepts inputs from the user through touchscreen 14. The touch inputs are converted by processor 16 to screen coordinates and are acted upon by the application software.

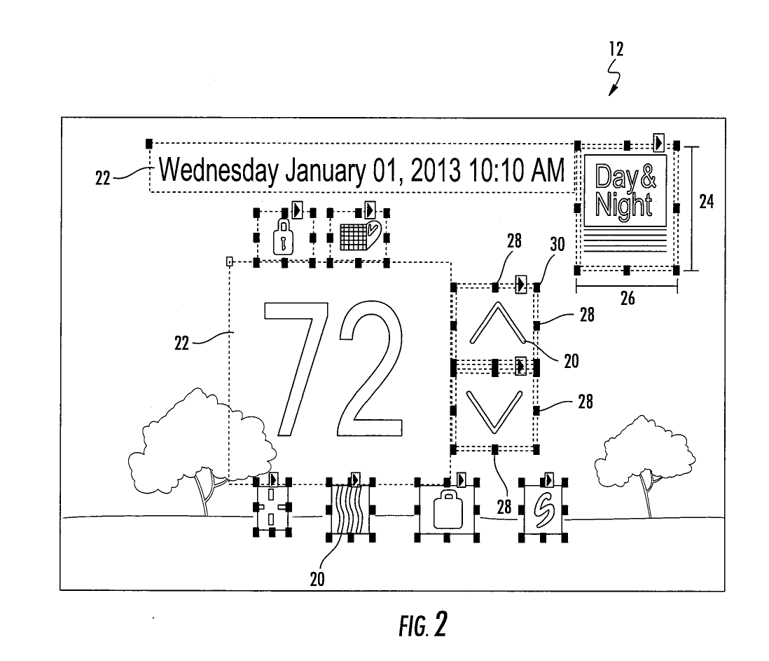

As shown in FIG. 2, the application software may provide visual feedback to the user through display screen 12 in the form of messages, data input graphical elements 20, and informational graphical elements 22, to display information and to designate locations for further touch inputs. For example, a data input graphical element 20 may comprise a digital “button” on the screen wherein the user may touch the “button” to provide an input to the processor 16. A data input graphical element 20 does not include a program launch graphical element or program launch application. An example of an information graphical element 22 may comprise visual information (e.g. time and date) provided as an output from the processor 16 to the display screen 12. In addition, the application software may cause processor 16 to provide outputs to other devices (not shown). Touchscreen 14 is positioned in front of the display screen 12, and is typically mounted as an overlay to display screen 12 during manufacturing. Touchscreen 14 electronically recognizes changes in a physical parameter, such as resistance, current, or ultrasonic waves resulting from a screen touch, to name just a few non-limiting examples. Those skilled in the art will recognize from the present disclosure that the method by which touchscreen 14 recognizes touch inputs from the user is not critical to the presently disclosed embodiments.

FIG. 2 further illustrates an embodiment of data input graphical elements 20 and informational graphical elements 22 on a display screen 12 executed by software stored in the memory 18, wherein each data input graphical element 20 and informational graphical element 22 includes a height dimension 24 and a width dimension 26. The entirety of each data input graphical element 20 and the entirety of each informational graphical element 22 may be selected to be moved to a desired location.

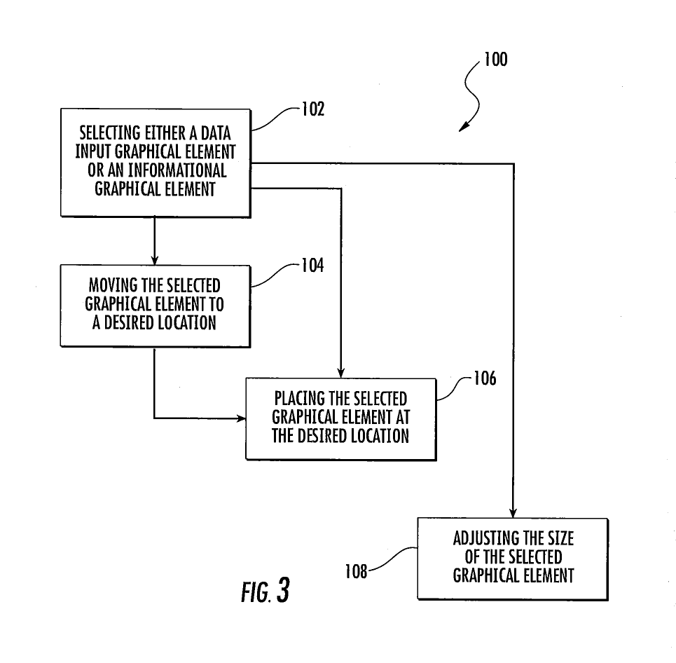

FIG. 3 illustrates an exemplary embodiment of a method to configure a user interface system 10 including software that generates at least one data input graphical element 20 and at least one informational graphical element 22 on a display screen 12, the method including the step 102 of selecting the entirety of at least one of the data input graphical element 20 or the entirety of at least one informational graphical element 22. In one embodiment, the display screen 12 may include a touchscreen. In one embodiment, step 102 may be performed by an end user. In one embodiment, either the entirety of the at least one data input graphical element 20 or the entirety of the at least one informational graphical element 22 may be selected by touching the touchscreen 14 with an object (not shown), where either the entirety of the at least one data input graphical element 20 or the entirety of the at least one informational graphical element 22 may be depicted on the display screen 12. It will be appreciated that the object may be any object which may electronically change a physical parameter of the touchscreen 14, for example a finger to name one non-limiting example.

Step 104 includes moving the entire selected data input graphical element 20 or the entire selected informational graphical element 22 to a desired location on the display screen 12. In one embodiment, step 104 may be performed by an end user. In one embodiment, the entire selected data input graphical element 20 or the entire selected informational graphical element 22 may be moved by sliding the object along the touchscreen 14, wherein the entire selected data input graphical element 20 or the entire selected informational graphical element 22 moves across the display screen 12 in concert with the object's movement.

Step 106 includes placing the entire selected data input graphical element 20 or the entire selected informational graphical element 22 at the desired location on the display screen 12. In one embodiment, step 106 may be performed by an end user. In one embodiment, the entire selected data input graphical element 20 or the entire selected informational graphical element 22 is placed at the desired location on the display screen 12 by removing the object from the touchscreen 14. In another embodiment, the entire selected data input graphical element 20 or the entire selected informational graphical element 22 may be placed by touching the touchscreen 14, in a second location where it is desired to place the entire selected data input graphical element 20 or the entire selected informational graphical element 22.

Referring to FIGS. 2 and 3, one embodiment of the method 100 further includes the Step 108 of adjusting the size of the selected data input graphical element 20 or the selected informational graphical element 22. In one embodiment, step 108 may be performed by an end user. At least one of the data input graphical elements 20 and at least one of the informational graphical elements 22 includes a height dimension 24 and a width dimension 26, wherein the height dimension 24 and the width dimension 26 are adjustable. In one embodiment, the height dimension 24 may be adjusted by the user touching the touchscreen 14 with an object at at least one point 28 and sliding the object in a vertical direction. In another embodiment, the width dimension 26 may be adjusted by touching the touchscreen 14 with an object at at least one point 28 and sliding the object in a horizontal direction. In another embodiment, the height dimension 24 and the width dimension 26 may be adjusted by touching the touchscreen 14 with the object at a corner 30, and sliding the object in a diagonal direction. In one embodiment, the height dimension 24 and the width dimension 26 may be adjusted by touching the touchscreen 14 with a pair of objects in close proximity to one another, and moving the pair of objects in opposite directions.

It will be appreciated that the user defined interface system may be configured on the touchscreen or the user defined interface system may be configured on a separate device and transferred to the user defined interface system. It will be appreciated that each of the data input graphical elements 20 and each of the informational graphical element 22, may be moved to a location on the display screen 12 to accommodate the preferences of a user. It will also be appreciated that the height dimension 24 and the width dimension 26 of each data input graphical element 20 and each informational graphical element 22 may be adjusted to accommodate the preferences of a user.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method for configuring a user defined interface system including software that generates at least one data input graphical element and at least one informational graphical element on a display screen, the method comprising the steps of:
(a) selecting the entirety of the at least one data input graphical element or the entirety of the at least one of informational graphical element; and
(b) moving the entire selected graphical element to a desired location.

2. The method of claim 1 wherein the display screen comprises a touchscreen.

3. The method of claim 1, wherein steps (a) and (b) are performed by an end user.

4. The method of claim 2, wherein step (a) comprises touching the touchscreen with an object where the entire at least one data input graphical element or the entire at least one informational graphical element may be depicted on the display screen.

5. The method of claim 4, wherein step (b) comprises sliding the object across the touchscreen, wherein the entire selected graphical element moves across the display screen in concert with the object's movement.

6. The method of claim 5, further comprising the step of placing the entire selected graphical element at the desired location; wherein placing the entire selected graphical element comprises removing the object from the touchscreen.

7. A method for configuring a user defined interface system including software that generates at least one data input graphical element and at least one informational graphical element on a display screen, the method comprising the steps of:
(a) selecting the entirety of at least one of the data input graphical element or the entirety of at least one of the informational graphical element; and
(b) placing the entire selected graphical element at the desired location.

8. The method of claim 7, wherein the display screen comprises a touchscreen.

9. The method of claim 7, wherein steps (a) and (b) are performed by an end user.

10. The method of claim 7, wherein step (a) comprises touching the touchscreen with an object where the entire of the at least one data input graphical element or the entire of the at least one informational graphical element may be depicted on the display screen.

11. The method of claim 10, wherein step (b) comprises touching the touchscreen in a second location where it is desired to place the entire selected graphical element.

12. A method for configuring a user defined interface system including software that generates at least one data input graphical element and at least one informational graphical element on a display screen, the method comprising the steps of:
(a) selecting either the entirety of the at least one data input graphical element or the entirety of the at least one informational graphical element; and
(b) adjusting the size of the entire selected graphical element.

13. The method of claim 12, wherein the display screen comprises a touchscreen.

14. The method of claim 12, wherein steps (a) and (b) are performed by an end user.

15. The method of claim 12, wherein step (a) comprises touching the touchscreen with an object where the entire of the at least one data input graphical element or the entire of the at least one informational graphical element may be depicted on the display screen.

16. The method of claim 12, wherein the entire selected graphical element comprises a height dimension and a width dimension.

17. The method of claim 15, wherein both the height dimension and the width dimension are adjustable.

18. The method of claim 15, wherein the height dimension is adjusted by touching the touchscreen with an object at at least one point and sliding the object in a vertical direction.

19. The method of claim 15, wherein the width dimension is adjusted by touching the touchscreen with an object at at least one point and sliding the object in a horizontal direction.

20. The method of claim 15, wherein the height dimension and the width dimension may be adjusted by touching the touchscreen with an object at a corner of the at least one data input graphical element and sliding the object in a diagonal direction.

21. The method of claim 15, wherein the height dimension and the width dimension may be adjusted by touching the touchscreen with a pair of objects in close proximity to one another, and moving the pair of objects in opposite directions.

22. A user defined interface system comprising:
a processor;
a memory;
a touchscreen display; and
executable software stored in the memory;
wherein the executable software generates a plurality of graphical elements on the display screen;
wherein at least one graphical element comprises a data input graphical element;
wherein at least one graphical element comprises an informational graphical element; and
wherein the entirety of the at least one data input graphical element or the entirety of the at least one informational graphical element may be selected by an end user to be moved to a desired location.

23. The user defined interface system of claim 22, wherein the entire of the at least one data input graphical element or the entire of the at least one informational graphical element may be selected by touching the touchscreen with an object where the entire at least one graphical element is depicted on the display screen.

24. The user interface of claim 23, wherein the entire selected graphical element may be moved by sliding an object across the touchscreen to a desired location to be placed, wherein the entire selected graphical element moves across the display screen in concert with the object's movement.

25. The user defined interface system of claim 23, wherein the entire selected graphical element may be placed by touching the touchscreen, in a second location where it is desired to place the entire at least one graphical element.

26. The user defined interface system of claim 24, wherein the entire selected graphical element may be placed by removing the object from the display screen.

27. The user defined interface system of claim 22, wherein each data input graphical element and each informational graphical element includes a height dimension and a width dimension.

28. The user defined interface system of claim 27, wherein the height dimension and the width dimension may be adjustable.

29. The user defined interface system of claim 28, wherein the height dimension may be adjusted by first selecting the at least one graphical element; then, touching the display screen with an object, at at least one point and sliding the object in a vertical direction.

30. The user defined interface system of claim 28, wherein the width dimension may be adjusted by first selecting the at least one graphical element; then, touching the display screen with an object, at at least one point and sliding the object in a horizontal direction.

31. The user defined interface system of claim 28, wherein the height dimension and the width dimension may be adjusted by first selecting the at least one graphical element; then, touching the display screen, with an object, at a corner of the at least one graphical element and sliding the object in a diagonal direction.

32. The user interface system of claim 28, wherein the height dimension and the width dimension may be adjusted by touching the touchscreen with a pair of objects in close proximity to one another, and moving the pair of objects in opposite directions.
